(19) United States
(12) Patent Application Publication
(10) Pub. No.: US 2019/0382269 A1
(43) Pub. Date: Dec. 19, 2019

(54) HELICAL CARBON NANOTUBES

(71) Applicant: Wichita State University, Wichita, KS (US)

(72) Inventors: Davood Askari, Wichita, KS (US); Sean Reza Taklimi, Wichita (YS); Ali Ghazinezami, Wichita, KS (US)

(73) Assignee: Wichita State University, Wichita, KS (US)

(21) Appl. No.: 16/421,049

(22) Filed: May 23, 2019

Related U.S. Application Data
(60) Provisional application No. 62/675,585, filed on May 23, 2018.

(51) Int. Cl. C01B 32/168; C08J 5/04; C08J 5/06

(52) U.S. Cl. CPC C01B 32/168; C08J 5/06; C08J 5/047

(57) ABSTRACT

Helical carbon nanotubes and the chemical functionalization of helical carbon nanotubes for use in high-performance multifunctional nanocomposite materials are described. Various processes of preparing functionalized helical carbon nanotubes and materials incorporating these nanotubes are also described.

### CROSS REFERENCE TO RELATED APPLICATIONS

This application claims the benefit of U.S. provisional application Ser. No. 62/675,585 filed May 23, 2018, the entire disclosure of which is incorporated herein by reference.

### FIELD

In general, the present invention relates to helical carbon nanotubes and the chemical functionalization of helical carbon nanotubes for use in high-performance multifunctional nanocomposite materials. Other aspects relate to processes of preparing functionalized helical carbon nanotubes and materials incorporating these nanotubes.

### BACKGROUND

There is increasing demand for high-performance materials with desired properties and multifunctional capabilities for a wide range of applications. For example, there is a need for new materials with improved properties, multifunctionality, and performance for a broader range of applications (e.g., space and aerospace structures, electronic and biomedical devices and sensors, energy and materials storage, sporting goods, gears, and automotive industry).

Traditional structural composites tend to have weak through-the-thickness and interlaminar properties. In addition, when laminated composite parts are manufactured using unidirectional and/or 2-D woven fabric reinforcement, the interlaminar and through-the-thickness properties are controlled by the weak matrix, since the adjacent layers and fibers are bonded by the matrix only, yielding poor interlaminar and through-the-thickness properties. This weakness often leads to interlaminar failures (such as delamination) in composites. To overcome this problem, 3-D composites such as 3-D stitching, 3-D braiding, and Z-pinning have been proposed that do not solve the general-purpose applications, since the part thickness should be known in advance and the materials properties are compromised in plane directions. Above all, the traditional composites lack room for multifunctionality.

Owing to their exceptional properties and characteristics, nanomaterials and nanostructures have played important roles in advancing the science and technologies utilized in many applications including medicine [1, 2], energy storage and conversion [3, 4], nanosensors and devices [5-7], advanced materials [8, 9], and nanocomposites [10, 11]. Among the many types of nanomaterials and nanostructures, carbon nanotubes (CNTs) have attracted a great deal of interest for applications in high-performance materials and structures, due to their outstanding mechanical [12-14], thermal [15-17], electrical [18, 19], and electromagnetic shielding [20]properties. In general, composite material systems are composed of two main parts: the reinforcement phase and the matrix phase. The reinforcement phase primarily handles the external loads, and the matrix phase protects and bonds the reinforcements together and has weak mechanical properties. Incorporation of CNTs with their unique properties can enhance and tune the properties of polymeric nanocomposites for specific applications. In addition, the low density of 1.3 g/cm³ [21] of CNTs can be another interesting factor for application of these nanomaterials for improvement of nanocomposite properties, without adding a considerable amount of weight. However, CNTs have nearly perfect crystalline structures that do not have much tendency to form new covalent bonds with polymer molecules. In addition, the presence of Van der Waals attractive forces between the CNTs results in their agglomeration and prevents their uniform dispersion in the resin systems. To solve this problem, one approach is to modify the sp² bond [22] of carbon-carbon on the surface of CNTs to increase its tendency for bonding to other molecules and materials (e.g., molecular chains of polymeric resins).

Covalent functionalization techniques can be used as an effective way of achieving improved bonding and uniform dispersion of CNTs in polymeric and/or ceramic resins. This can be accomplished through the alternation of the CNTs' atomic structures and attachment of different functional groups on their side-walls. However, carbon nanotubes exist in various geometrical configurations [23-28]. Therefore, there remains a need for appropriate methods and procedures for effective functionalization of CNTs, considering their structural configurations (e.g., straight, helical, and toroidal), characteristics, and the resin systems that they will be incorporated in.

### BRIEF SUMMARY

In general, the present invention relates to helical carbon nanotubes and the chemical functionalization of helical carbon nanotubes for use in high-performance multifunctional nanocomposite materials. Other aspects relate to processes of preparing functionalized helical carbon nanotubes and materials incorporating these nanotubes.

Various embodiments are directed to nanocomposite materials. In some embodiments, these nanocomposite materials comprise a first microfiber; a second microfiber; and a plurality of chemically functionalized helical nanostructures coupling the first and second microfibers, and the plurality of nanostructures comprise helical carbon tubes.

Further embodiments are directed to processes for preparing functionalized helical carbon nanotubes. Various processes comprise mixing a helical carbon nanotube with an acid in reaction mixture to form a functionalized helical carbon nanotube.

Other embodiments are directed to a functionalized helical carbon nanotube prepared according to any of the processes as described herein.

Still other embodiments are directed to processes for preparing a nanocomposite material. Various processes comprise mixing a microfiber with a functionalized helical carbon nanotube prepared according to any of the processes described herein.

The details of one or more embodiments of the invention are set forth in the accompanying drawings and the description herein. Other features, objects, and advantages of the invention will be apparent from the description and drawings, and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 presents (a) a SEM image of example entangled and interlocked coiled and straight carbon nanotubes in accordance with some embodiments provided herein, (b) another SEM image of example entangled and interlocked coiled and straight carbon nanotubes in accordance with some embodiments provided herein, (c) an SEM image of example individual carbon nanotube coils in accordance with some embodiments provided herein, and (d) another SEM image of example individual carbon nanotube coils in accordance with some embodiments provided herein.

FIG. 2 shows (a) some example traditional materials (e.g., glass, Kevlar®, and carbon fibers) that can be used in conjunction with the carbon nanotube coils described herein, (b) an example unidirectional carbon fiber tape, without stitching, that the carbon nanotube coils described herein can be used in conjunction with, (c) an example unidirectional carbon fiber tape, with stitching, that the carbon nanotube coils described herein can be used in conjunction with, (d)-(f) examples of carbon and Kevlar® woven fabric that the carbon nanotube coils described herein can be used in conjunction with, (g) an example glass-carbon woven fabric that the carbon nanotube coils described herein can be used in conjunction with, (h) an example glass-carbon-Kevlar® hybrid woven fabric that the carbon nanotube coils described herein can be used in conjunction with, (i) an example braided biaxial sleeve construction that the carbon nanotube coils described herein can be used in conjunction with, (j) an example carbon fiber randomly oriented continuous mat that the carbon nanotube coils described herein can be used in conjunction with, and (k) an example glass fiber randomly oriented continuous mat that the carbon nanotube coils described herein can be used in conjunction with.

FIG. 3 illustrates (a) and (b) how the carbon nanotube coils described herein can be entangled and mechanically interlocked with example microfiber-reinforcement strands to provide systems with desirable properties.

FIG. 4 presents (a)-(d) SEM images of straight and curved carbon nanotubes (20-50 nm diameters) that are highly entangled and mechanically interlocked together and with carbon fibers (˜6 μm diameters) within a microfiber bundle.

FIG. 5 provides a schematic of a functionalization process with detailed steps and processing parameters.

FIG. 6 provides a schematic of Method 1 functionalization process with detailed steps and processing parameters.

FIG. 7 provides a schematic of Method 2 functionalization process with detailed steps and processing parameters.

FIG. 8 provides a schematic of Method 3 functionalization process with detailed steps and processing parameters.

FIG. 9 presents dispersion test results for functionalized helical CNTs.

FIG. 10 presents dispersion test results for functionalized helical CNTs—Method 1, Part 1.

FIG. 11 presents dispersion test results for functionalized helical CNTs—Method 1, Part 2.

FIG. 12 presents dispersion test results for functionalized helical CNTs—Method 2, Part 1.

FIG. 13 presents dispersion test results for functionalized helical CNTs —Method 2, Part 2.

FIG. 14 presents dispersion test results for functionalized helical CNTs—Method 3, Part 1.

FIG. 15 presents dispersion test results for functionalized helical CNTs—Method 3, Part 2.

FIG. 16 presents and compares the two Raman spectral peaks of the functionalized HCNTs samples with respect to the pristine HCNTs and it illustrates the ratio of (I_{D}/I_{G}) bands.

FIG. 17 shows the FTIR spectra of the chemically functionalized HCNTs in comparison to the pristine HCNTs sample.

FIG. 18 shows the XRD data for the pristine and the chemically functionalized HCNTs.

FIG. 19 shows the SEM images (i.e., in various magnifications) of the pristine HCNTs that were used in this study for chemical functionalization.

FIG. 20 shows the SEM images (i.e., at ×15,000 magnification) of the HCNTs after they were chemically functionalized using 9 different procedures (i.e., M1 through M9).

FIG. 21 presents SEM images for FHCNTs that were functionalized using sub-method 8 of the Method 3 (M308) with (a) 5000×, (b) 10000×, (c) 15000×, and (d) 22000× magnifications.

Like reference numbers represent corresponding parts throughout.

### DETAILED DESCRIPTION

In general, the present invention relates to helical carbon nanotubes and the chemical functionalization of helical carbon nanotubes for use in high-performance multifunctional nanocomposite materials. Other aspects relate to processes of preparing functionalized helical carbon nanotubes and materials incorporating these nanotubes.

Various aspects of the present invention relate to helical carbon nanotubes. For example, various embodiments are directed to chemical functionalized helical carbon nanotubes (FHCNTs) useful for high-performance multifunctional nanocomposite materials. In some embodiments, the nanocomposite materials described herein can have chemically functionalized nanomaterials that are highly bent, kinked, twisted, entangled and mechanically interlocked within a resin system and with traditional microfiber reinforcements to meet demands for high-performance materials with desired properties and multifunctional capabilities for a wide range of applications. Accordingly, such materials provide high-performance properties in contexts such as, but not limited to, structural load carrying, efficient heat transfer, and efficient electricity transfer. Depending on the choice of nano-reinforcement and/or micro-reinforcement phases, such a nanocomposite material can provide superior mechanical, electrical, thermal, magnetic, and optical properties in the thickness (i.e., transverse) and other directions, regardless of the electrical and thermal characteristics of the resin system. Furthermore, due to highly entangled fibrous nature of the reinforcement phases that have improved atomic bonding with the host resin, such a material provides extraordinary penetration and impact resistance. Moreover, the three-dimensional nanocomposite materials have a wide range of applications, and can be used in high-performance light-weight materials.

A helical carbon nanotube (HCNT) is considered as one of the geometrical configurations of CNTs. According to their structural shape, these HCNTs have the potential to be used for a variety of applications such as medical devices, solenoids, shock absorbing devices, cellular technology, electromagnets, and nanocomposites. Furthermore, their coil shape gives them the ability to respond to the external loads like a coil spring that can sustain large deformations and return to their original shape and length after unloading. Therefore, HCNTs have a good potential to deliver good mechanical properties and especially higher fracture toughness compared to the straight CNTs, when they are used as additional reinforcements in composite material systems. In addition, HCNTs can be used for improving the microwave absorbing properties of composites. HCNTs can interlock within a resin system, once they are used as reinforcements, and they cannot be easily pulled out of the resin, due to their geometrical configuration. Furthermore, they can be entangled and mechanically interlocked with each other and the microfiber reinforcements in addition to being stuck in the surrounding cured resin. However, they suffer from weak interface bonding with the surrounding resin, due to their inertness and lack of tendency for formation of new chemical bonds. To address this issue, we have found that chemical functionalization can be used to chemically functionalize the helical CNTs and improve their interface bonds with the surrounding resin molecules.

Helical configurations of HCNTs are formed due to the existence of periodically repeated pentagonal/heptagonal carbon rings, which is the indication of atomic defects on their side-walls that are formed during the synthesis process [14, 29-34]. These defects make the chemical functionalization of HCNTs quite different from the chemical functionalization of straight CNTs, meaning that it requires special consideration regarding the chemical functionalization method (e.g., sonication and refluxing processes) and processing parameters (e.g., acid types, solution mixture composition, mixing ratios, acid molarities, processing temperature, and processing time). Typically, the chemical functionalization processes described herein use different types of strong oxidants to alter the surface of CNTs for attachment of functional groups and improvement of their solubility in liquid resins. Furthermore, one of the advantages of these chemical functionalization methods is the increased bond strength between functional groups attached to the surface of CNTs and the resin molecules.

Accordingly, various embodiments of the present invention are directed to processes for preparing functionalized helical carbon nanotubes as well as the functionalized helical carbon nanotube prepared according to these processes. For example, one process comprises mixing a helical carbon nanotube with an acid in reaction mixture to form a functionalized helical carbon nanotube.

These processes can include additional steps. For example, in some embodiments, the process further comprises separating the functionalized helical carbon nanotube from the reaction mixture. In certain embodiments, the functionalized helical carbon nanotube is separated from the reaction mixture by filtration. Also, the process can further comprise drying the functionalized helical carbon nanotube. In various embodiments, the process further comprises sonicating the reaction mixture.

Typically, the helical carbon nanotube is mixed with an acid comprising a strong acid. In some embodiments, the acid comprises a mineral acid. In certain embodiments, the acid comprises sulfuric acid and/or nitric acid. In various embodiments, the acid comprises a combination of sulfuric acid and nitric acid at a molar ratio from about 1:1 to about 10:1, from about 1:1 to about 5:1, from about 1:1 to about 3:1, from about 2:1 to about 10:1, from about 2:1 to about 5:1, from about 2:1 to about 3:1 (e.g., about 3:1).

The concentration of the acid that in the reaction mixture is typically at least about 1 M, at least about 2 M, at least about 3 M, or at least about 6 M. For example, the reaction mixture can have a concentration of acid that is from about 1 M to about 20 M, from about 1 M to about 16 M, from about 1 M to about 12 M, from about 1 M to about 8 M, from about 1 M to about 4 M, from about 2 M to about 20 M, from about 2 M to about 16 M, from about 2 M to about 12 M, from about 2 M to about 8 M, from about 2 M to about 4 M, from about 3 M to about 20 M, from about 3 M to about 16 M, from about 3 M to about 12 M, from about 3 M to about 8 M, or from about 3 M to about 4 M.

The reaction mixture is typically maintained at a temperature of at least about 50° C., at least about 60° C., at least about 70° C., at least about 80° C., at least about 90° C., or at least about 100° C. For example, the reaction mixture can be maintained at a temperature of from about 50° C. to about 120° C., from about 60° C. to about 120° C., from about 80° C. to about 120° C., from about 50° C. to about 100° C., from about 60° C. to about 100° C., or from about 80° C. to about 100° C.

In some embodiments, the process further comprises refluxing a solution comprising acid with the reaction mixture. In various embodiments, the solution comprising acid comprises the acid(s) contained in the reaction mixture (i.e., the aforementioned acid). The solution comprising acid refluxed with the reaction mixture can be maintained a temperature of at least about 50° C., at least about 60° C., at least about 70° C., at least about 80° C., at least about 90° C., or at least about 100° C. For example, the solution comprising acid can be at a temperature of from about 50° C. to about 120° C., from about 60° C. to about 120° C., from about 80° C. to about 120° C., from about 50° C. to about 100° C., from about 60° C. to about 100° C., or from about 80° C. to about 100° C.

Various helical carbon nanotubes can be functionalized by the processes described herein. In some embodiments, the helical carbon nanotube has an outside diameter ranging from about 100 nm to about 200 nm. Further, the helical carbon nanotube can have a helical coil pitch ranging from about 500 nm to about 1000 nm. Also, the helical carbon nanotube can have a length ranging from about 1 micron to about 10 microns.

Various FHCNTs that can be prepared by the processes described herein can be characterized by one or more of the following:

(a) a plurality of the FHCNTs forms a stable suspension with water at room temperature, wherein at least about 75 wt. %, at least about 90 wt. %, at least about 95 wt. %, or at least about 99 wt. % of the FHCNT remains suspended in the water after one week of storage at room temperature;

(b) an amount of the FHCNTs forms a suspension in water at room temperature having a greater optical opacity as compared to a suspension having approximately the same amount of an otherwise similar helical carbon nanotubes, but which are pristine/non-functionalized;

(c) the FHCNT has an increased I_{D}/I_{G} value as determined by Raman spectroscopy as compared to an otherwise similar helical carbon nanotube, but which is pristine/non-functionalized;

(d) the FHCNT exhibits a decrease crystallinity as determined by X-Ray diffraction as compared to an otherwise similar helical carbon nanotube; and/or

(e) the FHCNT has a peak at 26° as determined by X-Ray diffraction that is less than the peak 26° for an otherwise similar helical carbon nanotube.

Various embodiments of the present invention are also directed to a liquid composition comprising a plurality of FHCNTs as described herein dispersed in a liquid medium. For example, the liquid medium can comprise water.

Further embodiments are directed to a composite material comprising a plurality of FHCNTs as described herein and at least one additional component. The additional component can comprise, for example, at least one material selected from the group consisting of glass, polymer, ceramic, metal, carbon, silicon carbide, boron, aluminum oxide, and combinations thereof. Also, in some embodiments, the additional components comprise a matrix phase and a reinforcement phase. In certain embodiments, the matrix phase comprises a polymeric resin. In various embodiments, the reinforcement phase comprises a material different than the matrix phase.

As noted, embodiments of the present invention are also directed to various nanocomposite materials. In some embodiments, these nanocomposite materials comprise a first microfiber; a second microfiber; and a plurality of chemically functionalized helical nanostructures coupling the first and second microfibers. In various embodiments, at least a portion of the plurality of chemically functionalized helical nanostructures couple with the first fiber and adjacent nanostructures.

The chemically functionalized helical nanostructures can be selected from the group consisting of carbon, boron nitride, silicon, silicon carbide, silver-gallium, platinum, silver, metal oxides, and combinations thereof. In various embodiments, the chemically functionalized helical nanostructures comprise carbon. In certain embodiments, the chemically functionalized helical nanostructures comprise functionalized helical carbon nanotubes. In some embodiments, each helical tube of the helical carbon nanotube has a tube diameter of about 1 nm to about 100 nm.

In various embodiments, the first microfiber, the second microfiber, or both, are selected from the group consisting of glass, a para-aramid synthetic fiber, carbon, silicon carbide, boron, aluminum oxide, or combinations thereof.

In some embodiments, the chemically functionalized helical nanostructures have an elongate body with a length of greater than 2 microns. For example, the chemically functionalized helical nanostructures can have an elongate body with a length ranging from about 10 microns to about 50 microns, from about 50 microns to about 100 microns, from about 100 microns to about 500 microns, from about 500 microns to about 1000 microns, or from about 1000 microns to about 10000 microns.

The amount of chemically functionalized helical nanostructures in the nanocomposite material can be less than about 1%, less than about 0.5%, or less than about 0.2% by weight of the nanocomposite material. For example, the amount of chemically functionalized helical nanostructures can range from about 0.02% to about 1% by weight of the nanocomposite.

The total amount of microfibers can range from about 10% to about 70% by weight of the nanocomposite material.

In various embodiments, the nanocomposite material further comprises a resin matrix in which the first microfiber, the second microfiber, and the plurality of chemically functionalized helical nanostructures are embedded uniformly therein. In some embodiments, the resin matrix comprises an epoxy polymer.

In various embodiments, the first and second microfibers are comprised within a bundle, tow, or yarn of microfibers that are coupled together by the plurality of chemically functionalized helical nanostructures within the nanocomposite material.

In some embodiments, each chemically functionalized helical nanostructure has a coil diameter of about 50 nm to about 500 nm, from about 100 nm to about 300 nm, or from about 200 to about 300 nm.

In various embodiments, the nanocomposite material comprises a plurality of microfibers.

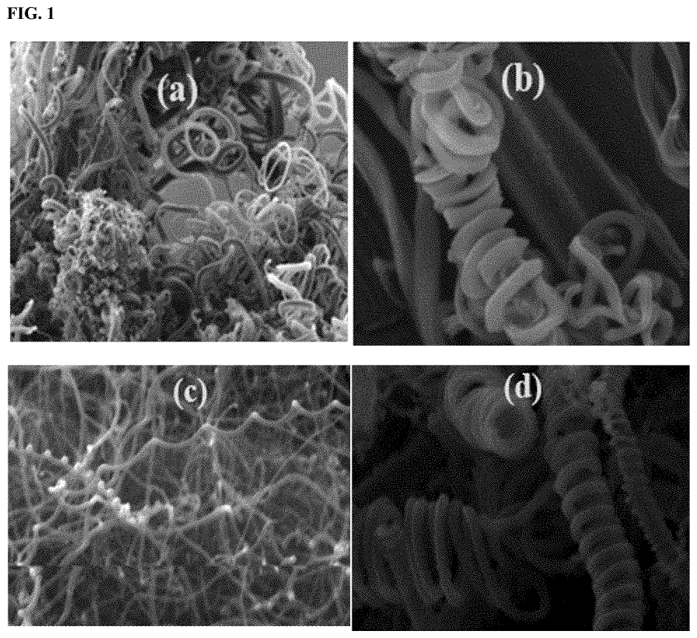

FIG. 1 shows SEM images of chemically functionalized nanomaterials in helical configurations with high-aspect-ratios (e.g., carbon nanotube long helical coils) according to the present invention. The chemically functionalized nanomaterials are highly bent, kinked, twisted, entangled and mechanically interlocked within the resin system and the traditional microfiber reinforcements. One benefit for chemical functionalization of HCNTs is the improvement of their dispersion and interface atomic bonding with the molecules of the host resin system used for fabrication of traditional composite materials.

The nanocomposite materials that are described herein somewhat analogous to the structures of some very high-performance natural fibrous materials that have been observed in plants (e.g., silk, spider net, and bird nest) and some living animal's certain organs (e.g., gecko foot). Nanostructured materials, even in very small quantities, provide tremendously large surface areas and interfaces that can participate in chemical reactions, form chemical bonds with adjacent materials, or provide attractive Van der Waals forces, in billions of billions in number.

In addition to the improved chemical bond formations and attractive Van der Waals forces at the interfaces of nanomaterials (that are present in billions of billions), the resin molecules and individual fiber strands can also be mechanically entangled and interlocked with individual helical carbon nanotubes and the cured matrix. Such a highly entangled and mechanically interlocked chemically functionalized multiscale materials can present exceptionally high mechanical, thermal, and electrical properties, with higher durability, when they are exposed to harsh environmental conditions. Such structures address one of the most common problems and weaknesses of known composite material systems (i.e., low interlaminar and through-the-thickness properties). Hence, the structures described herein can greatly advance the composite materials industry in a wide range of high-performance materials applications.

The highly-reinforced chemically functionalized nanocomposite materials as described herein can be used to make high-performance materials for a wide range of applications where traditional composites materials are commonly used (e.g., marine and submarine structures, space and aerospace structures, wind turbines, biomedical devices and sensors, electronics, MEMS and NEMS, sporting goods, automotive industry, building materials, transportation industry, piping, materials storage, etc.). These materials are beneficial for the space and aerospace, marine and submarine, automotive, sport, medical, electronic, oil and gas, and renewable energy related industries. Moreover, the technology described herein can easily be scaled up to produce high-performance FHCNTs reinforced multifunctional nanocomposite material systems in large quantities that are highly reliable and reproducible.

In some previous works, CNTs were grown on various fiber bundles and fabrics at elevated temperatures (e.g., 770° C.) that could have damaged the fiber. In addition, the CNTs were all substantially straight with no mechanical entanglements with individual fiber strands and/or with the laminae. Furthermore, the nanotubes were grown only on the fibers that were positioned on the outside periphery of the fiber bundles and tows that constructed the fabrics. Therefore, previously proposed methods do not introduce nanomaterials in between the individual fiber strands within the fiber bundles/tows/yarns that make up the reinforcing fabrics.

In some cases, high-aspect-ratio nanomaterials (e.g., helical CNTs) can be placed in between the laminae and individual fiber strands within the fiber bundles/tows/yarn that are mechanically entangled together and the fiber strands, all at room temperature. The CNTs can be entangled-interlocked with each other and the fiber reinforcements, creating a continuous network of highly reinforced fibrous mat that can be used to fabricate high-performance multifunctional nanocomposites. In addition, HCNTs can be incorporated within a resin system as well. The presence of highly entangled network of HCNTs that are interlocked with each other and stuck inside the resin system can further improve properties of resin systems, in addition to the entanglement and interlocking of HCNTs with the microfiber reinforcements. Because of their helical configurations, HCNTs cannot be easily pulled out of the solidified resin. These CNTs with their superior properties and flexibility provide excellent interlaminar reinforcement in transverse and other directions, and enhance the multifunctionality of laminated composite materials. However, their effectiveness depends on their interaction (i.e., interface bonding) with the resin molecules.

The FHCNTs (prepared using the functionalization processes described herein that provide for improvement of the HCNTs interface bonding with resin molecules) can be used in between laminae and individual fiber strands within fiber bundles/tows/yarn that are mechanically entangled together and the fiber strands. The FHCNTs described herein exhibit improved atomic bonding within a resin system. The FHCNTs can entangle/interlock with each other and the fiber reinforcements, thereby creating a continuous network of highly reinforced fibrous mat that can be used to fabricate high-performance nanocomposites. These FHCNTs provide excellent interlaminar reinforcement in transverse and other directions and enhance the performance and multifunctionality of laminated composite materials. Various methods and techniques can be used for the incorporation of carbon nanotubes (i.e., with straight and helical configurations in pristine and/or functionalized forms) over and in between the fiber strands that compose the fiber bundles/tows/yarn and laminae. For example, electrically charged (e.g., positive charge) FHCNTs (in powder form and/or suspended in DI water in liquid form) can be sprayed inside a chamber, where electrically charged (i.e., with opposite charge, e.g., negative) microfibers (i.e., carbon, glass, Kevlar, silicon carbide, etc.) is passing through in spread and individually separated form. The positively charged functionalized HCNTs can be attracted and deposited over and around the negatively charged separated/suspended individual fiber strands and can be collected/grouped and bundled together in form of fiber bundles/tows/yarns and or unidirectional tapes. As a result, theses fiber bundles/tows/yarns and or unidirectional tapes can include FHCNTs that are effectively incorporated over and in between all the fiber filaments. As another example, the FHCNTs can be suspended and dispersed very uniformly in DI water (i.e., as a results of chemical functionalization).

Microfibers (i.e., carbon, glass, Kevlar, silicon carbide, etc.) can pass through a FHCNTs-DI water solution in spread and individually separated form. The FHCNTs can be deposited and collected over and around the separated/suspended individual fiber strands. The strands can be collected/grouped and bundled together in form of fiber bundles/tows/yarns and or unidirectional tapes. As a result, theses fiber bundles/tows/yarns and or unidirectional tapes can include FHCNTs that are effectively incorporated over and in between all the fiber filaments. These microfiber bundles/tows/yarns containing CNTs (i.e., straight and helical configurations in pristine or chemically functionalized forms) in dry form or preimpregnated (impregnated with a rein system and B-staged, once they are dried after passing through the FHCNTs-DI water bath) can be used to weave dry fabrics and/or prepregs with unidirectional and bi-axial architectures. The FHCNTs incorporated fabrics and unidirectional tapes can be used to fabricate high-performance multifunctional nanocomposites.

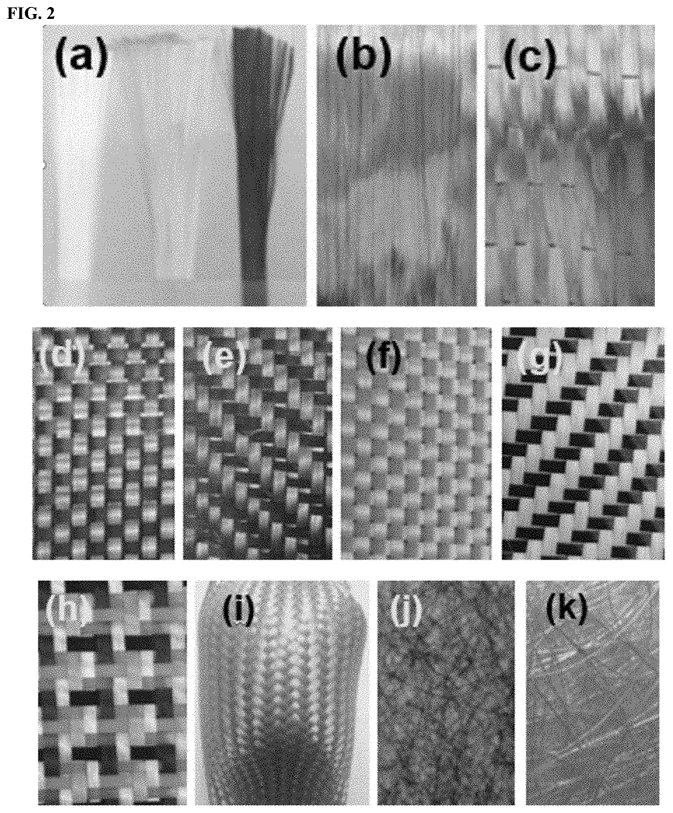

Referring to FIG. 2, the nanocomposite materials described herein can be used in conjunction with polymeric, metallic, and ceramic microfiber reinforcements (e.g., carbon, aramid, glass, silicon carbide, aluminum oxide, boron, aluminum, etc.) in various forms (e.g., dry or prepreg, continuous short and long, chopped, aligned, randomly oriented, etc.) configurations (e.g., fiber tows, bundles, unidirectional tapes, woven fabrics, non-woven mat, non-crimp fabrics, three-dimensional braded fabrics, non-woven non-crimp two-dimensional stitched fabrics, non-woven non-crimp three-dimensional fabrics, and any other architecture), and combinations (e.g., single fiber material or any hybrid forms that include two or more types for fibers). Such structures using the nanocomposite materials described herein in combination with one or more other materials provide various types of composites (e.g., laminated and sandwich) for high-performance applications. In terms of resin system involvement, it could involve polymeric, metallic, and ceramic matrices in their pristine, chemically modified, and or reinforced form with primary nanomaterial inclusion (e.g., the resin that has been already reinforced with primary nanomaterials that have geometry configurations other than helical coils).

For the highly entangled mechanically interlocked chemically functionalized nanoscale reinforcement phase, various types of nanomaterials (e.g., carbon based, boron nitride, silicon, silicon carbide, silver, platinum, silver-gallium, other metals, metal oxides, and other ceramic and polymeric nano- and micro-fibers) can be used in helical coil-like structural configurations (e.g., helical carbon nanotubes and carbon nanofibers).

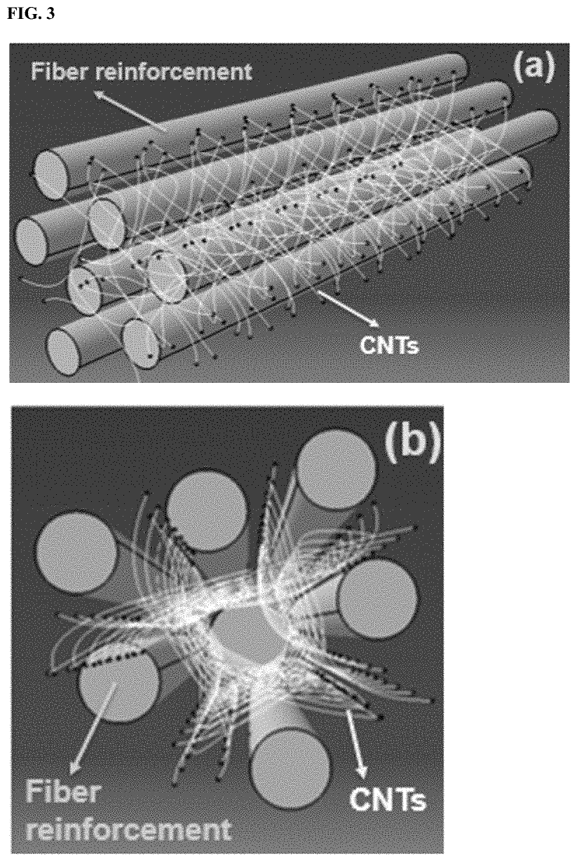

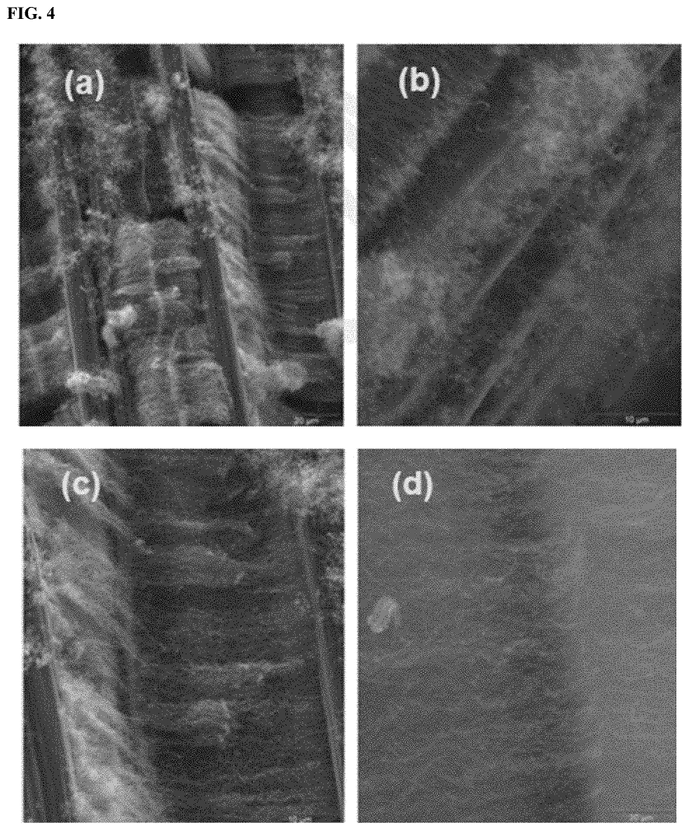

Referring to FIGS. 3 and 4, in some embodiments the high-performance nanocomposite materials described herein can be fabricated (e.g., thin layers of high-aspect-ratio helical nanomaterials and mono-fiber-thick layers of microfiber reinforcements can be assembled on top of and in between each other), layer-by-layer, being highly entangled and mechanically interlocked together, until the desired thickness is obtained. The interlayered stacks of microfiber-nanomaterials laminae can be impregnated with a resin system (that could have also been reinforced with chemically functionalized HCNTs) and then either B-staged and stored, or used directly to manufacture highly-reinforced nanocomposite materials and structures for high-performance applications. Due to their superior materials properties, helical geometrical configurations, and improved interface bonding with the resin system, the presence of high-aspect-ratio chemically functionalized helical nanomaterials and nanostructures that are highly entangled and mechanically interlocked with each other and with microfiber-reinforcement within each microfiber bundle/tow/yarn, the HCNTs can considerably improve the load transfer capability of the resin system. HCNTs can also participate to carry structural loads and transfer heat and electricity, very efficiently. In addition, the functionalized nano-reinforcement phase, which is highly entangled and interlocked with the microfiber-reinforcement phase, can act as a mechanical medium that can resist the deformation, movement, failure of the microfibers and improve the inter-laminar and transverse properties of composite structures.

The nanocomposite materials can resemble the structure of a bird nest that is made from natural fibers and thin tree branches (i.e., with improved interface atomic scale bonding with mud, here as the resin system) with various thicknesses that are highly entangled and mechanically interlocked together and embedded in mud. Depending on the choice of nano-reinforcement and micro-reinforcement phases, such a nanocomposite material can provide superior mechanical, electrical, thermal, magnetic, and optical properties in the thickness (i.e., transverse) and other directions, regardless of the electrical and thermal characteristics of the resin system. Furthermore, due to highly entangled fibrous nature of the reinforcement phases that have improved atomic bonding with the host resin, such a material is expected to have extraordinary penetration and impact resistance. The three-dimensional nanocomposite materials have a wide range of applications and can be used in high-performance light-weight materials.

Considering the diameters of the fiber filaments that are used as reinforcements in traditional laminated high-performance composites (e.g., 5 to 30 micrometers), they are usually produced in bundle/tow/yarn forms (e.g., thousands of fiber strands twisted together or bundled side-by-side) and then woven together to create fabrics with different textures and composition or put together side-by-side to create unidirectional mat and tapes. In both forms, the nanomaterials reinforcements can be introduced in between the fiber tows/bundles/yarns within the woven fabrics or unidirectional/bidirectional tapes and mats.

### Examples

The following non-limiting examples are provided to further illustrate the present invention.

### Example 1: Chemical Functionalization of Helical CNTS

Materials and Instruments.

CNTs with helical configuration were purchased from Cheap Tubes Inc. with outside diameters ranging from 100 nm to 200 nm, the helical coil pitches ranging from 500 nm to 1000 nm, the lengths ranging from 1 to 10 m, and purity of more than 90%. For vacuum filtration of HCNTs solutions, a 0.4 μm polycarbonate filter was obtained and used from Fisher Scientific. For characterization of chemically functionalized HCNTs, various instruments and tools were utilized. A JEOL JSM-6460 LV scanning electron microscope was used for imaging of the FHCNTs. The XRD and Raman spectral were acquired using a MiniFlex diffractometer from the Rigaku Corporation and an XploRA™ PLUS microscope from the HORIBA company, respectively. Finally, two modules (Smart OMNISampler and DuraSamplIR from Thermo Scientific Company) were used for obtaining the FTIR spectrum of the FHCNTs.

Functionalization Process.

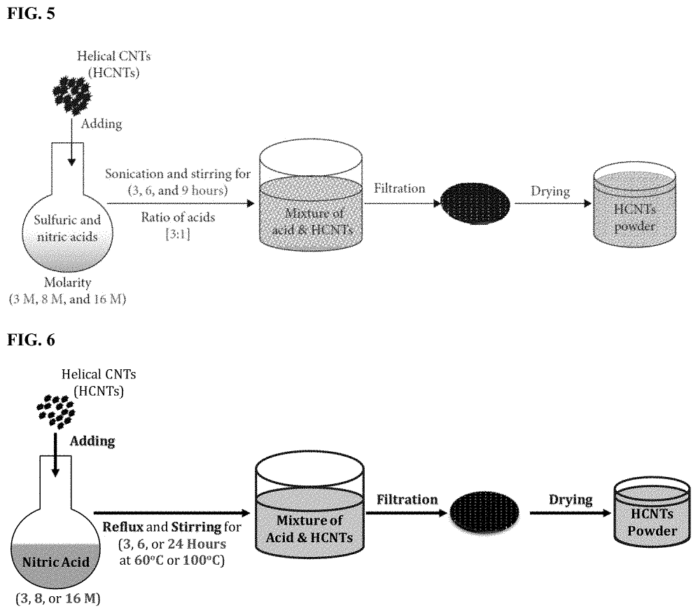

A sonication process with a mixture of sulfuric and nitric acid solution with 3 to 1 mixing ratio [3:1] was used for functionalization of HCNTs. The HCNTs were weighed and then added to the acid solution in a closed-cap container. Acid molarities (i.e., 3, 8, and 6 M) and sonication time (i.e., 3, 6, and 9 hours) were the two parameters which were investigated during the functionalization processes. The temperature during the sonication process was kept constant at 60° C. After the completion of the sonication process, the functionalized HCNTs were filtered using a vacuum filtration process. To verify that no acid remained in the filtered solution, the pH of the outlet water was checked continuously by a pH meter. In the last stage, the filter and trapped powder of functionalized HCNTs were placed in an oven at 120° C. for 4 hours for drying. The dried HCNTs were separated from the filter and then kept in a closed-cap glass container for further characterization. FIG. 5 displays the schematic of a chemical functionalization method. Table 1 provides the processing parameters used.

TABLE 1

| | M1 | M2 | M3 | M4 | M5 | M6 | M7 | M8 | M9 |
|---|---|---|---|---|---|---|---|---|---|
| Molarity (M) | 3 | 3 | 3 | 8 | 8 | 8 | 16 | 16 | 16 |
| Sonication Time (hr) | 3 | 6 | 9 | 3 | 6 | 9 | 3 | 6 | 9 |

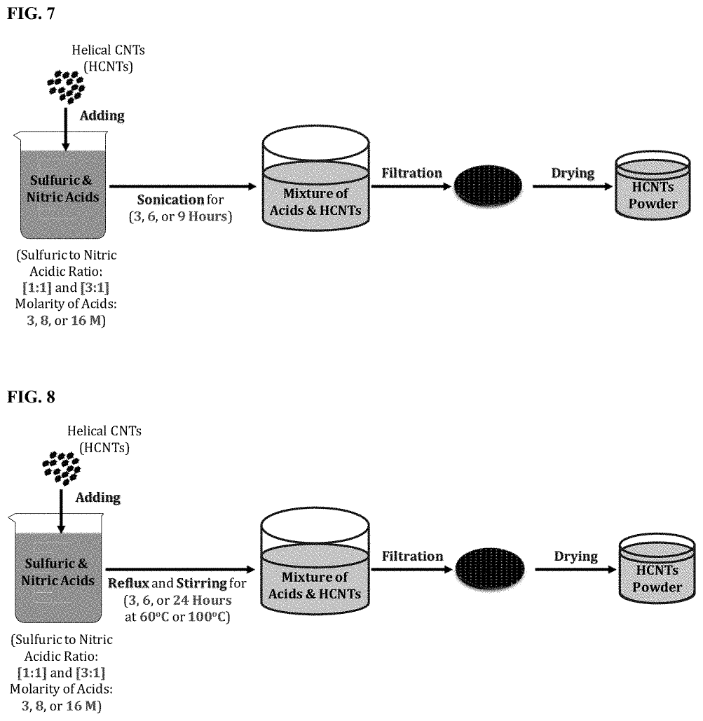

Additional series of functionalized HCNTs were prepared in similar manner. FIG. 6 presents a schematic of method 1 for chemical functionalization of HCNTs that includes reflux with nitric acid, while varying the acid molarity, reflux time, and reflux temperature. Table 2 presents the processing parameters for method 1 and includes a total of 18 various chemical functionalization processes (i.e., sub-methods M101, M102, M103, . . . ) that were used to chemically functionalize HCNTs. FIG. 7 presents a schematic of method 2 for chemical functionalization of HCNTs that includes sonication with a mixture of nitric and sulfuric acids, while varying the mixing ratio, acid molarity, and sonication time. Table 3 presents the processing parameters for method 2 and includes a total of 18 various chemical functionalization processes (i.e., sub-methods M201, M202, M203, . . . ) that were used to chemically functionalize HCNTs. FIG. 8 presents a schematic of method 3 for chemical functionalization of HCNTs that includes reflux with a mixture of nitric and sulfuric acids, while varying the mixing ratio, acid molarity, reflux time, and reflux temperature. Table 3 presents the processing parameters for method 3 and includes a total of 36 various chemical functionalization processes (i.e., sub-methods M301, M302, M303, . . . ) that were used to chemically functionalize HCNTs.

TABLE 2
Devised Functionalization Methods with Their Related Specific
Parameters for Processes of Method 1: Reflux with Nitric Acid

| Sub- | | Molarity | Reflux Time | Reflux Temperature |
|---|---|---|---|---|
| Method | Oxidant | (M) | (hr) | (° C.) |
| M101 | HNO₃ | 3 | 3 | 60 |
| M102 | HNO₃ | 3 | 3 | 100 |
| M103 | HNO₃ | 3 | 6 | 60 |
| M104 | HNO₃ | 3 | 6 | 100 |
| M105 | HNO₃ | 3 | 24 | 60 |
| M106 | HNO₃ | 3 | 24 | 100 |
| M107 | HNO₃ | 8 | 3 | 60 |
| M108 | HNO₃ | 8 | 3 | 100 |
| M109 | HNO₃ | 8 | 6 | 60 |
| M110 | HNO₃ | 8 | 6 | 100 |
| M111 | HNO₃ | 8 | 24 | 60 |
| M112 | HNO₃ | 8 | 24 | 100 |
| M113 | HNO₃ | 16 | 3 | 60 |
| M114 | HNO₃ | 16 | 3 | 100 |
| M115 | HNO₃ | 16 | 6 | 60 |
| M116 | HNO₃ | 16 | 6 | 100 |
| M117 | HNO₃ | 16 | 24 | 60 |
| M118 | HNO₃ | 16 | 24 | 100 |

TABLE 3
Devised Functionalization Methods with Related
Specific Parameters for Processes of Method
2: Sonication with Nitric and Sulfuric Acids

| Sub- | | | | Molarity | Sonication Time |
|---|---|---|---|---|---|
| Method | Oxidant 1 | Oxidant 2 | Ratio | (M) | (hr) |
| M201 | H₂SO₄ | HNO₃ | 1:1 | 3 | 3 |
| M202 | H₂SO₄ | HNO₃ | 1:1 | 3 | 6 |
| M203 | H₂SO₄ | HNO₃ | 1:1 | 3 | 9 |
| M204 | H₂SO₄ | HNO₃ | 1:1 | 8 | 3 |
| M205 | H₂SO₄ | HNO₃ | 1:1 | 8 | 6 |
| M206 | H₂SO₄ | HNO₃ | 1:1 | 8 | 9 |
| M207 | H₂SO₄ | HNO₃ | 1:1 | 16 | 3 |
| M208 | H₂SO₄ | HNO₃ | 1:1 | 16 | 6 |
| M209 | H₂SO₄ | HNO₃ | 1:1 | 16 | 9 |
| M210 | H₂SO₄ | HNO₃ | 3:1 | 3 | 3 |
| M211 | H₂SO₄ | HNO₃ | 3:1 | 3 | 6 |
| M212 | H₂SO₄ | HNO₃ | 3:1 | 3 | 9 |
| M213 | H₂SO₄ | HNO₃ | 3:1 | 8 | 3 |
| M214 | H₂SO₄ | HNO₃ | 3:1 | 8 | 6 |
| M215 | H₂SO₄ | HNO₃ | 3:1 | 8 | 9 |
| M216 | H₂SO₄ | HNO₃ | 3:1 | 16 | 3 |
| M217 | H₂SO₄ | HNO₃ | 3:1 | 16 | 6 |
| M218 | H₂SO₄ | HNO₃ | 3:1 | 16 | 9 |

TABLE 4
Devised Functionalization Methods with Their Related
Specific Parameters for Processes of Method 3:
Reflux with Nitric and Sulfuric Acids

| | | | | | Reflux | Reflux |
|---|---|---|---|---|---|---|
| Sub- | Oxidant | Oxidant | | Molarity | Time | Temperature |
| Method | 1 | 2 | Ratio | (M) | (hr) | (° C.) |
| M301 | H₂SO₄ | HNO₃ | 1:1 | 3 | 3 | 60 |
| M302 | H₂SO₄ | HNO₃ | 1:1 | 3 | 3 | 100 |
| M303 | H₂SO₄ | HNO₃ | 1:1 | 3 | 6 | 60 |
| M304 | H₂SO₄ | HNO₃ | 1:1 | 3 | 6 | 100 |
| M305 | H₂SO₄ | HNO₃ | 1:1 | 3 | 24 | 60 |
| M306 | H₂SO₄ | HNO₃ | 1:1 | 3 | 24 | 100 |
| M307 | H₂SO₄ | HNO₃ | 1:1 | 8 | 3 | 60 |
| M308 | H₂SO₄ | HNO₃ | 1:1 | 8 | 3 | 100 |
| M309 | H₂SO₄ | HNO₃ | 1:1 | 8 | 6 | 60 |
| M310 | H₂SO₄ | HNO₃ | 1:1 | 8 | 6 | 100 |
| M311 | H₂SO₄ | HNO₃ | 1:1 | 8 | 24 | 60 |
| M312 | H₂SO₄ | HNO₃ | 1:1 | 8 | 24 | 100 |
| M313 | H₂SO₄ | HNO₃ | 1:1 | 16 | 3 | 60 |
| M314 | H₂SO₄ | HNO₃ | 1:1 | 16 | 3 | 100 |
| M315 | H₂SO₄ | HNO₃ | 1:1 | 16 | 6 | 60 |
| M316 | H₂SO₄ | HNO₃ | 1:1 | 16 | 6 | 100 |
| M317 | H₂SO₄ | HNO₃ | 1:1 | 16 | 24 | 60 |
| M318 | H₂SO₄ | HNO₃ | 1:1 | 16 | 24 | 100 |
| M319 | H₂SO₄ | HNO₃ | 3:1 | 3 | 3 | 60 |
| M320 | H₂SO₄ | HNO₃ | 3:1 | 3 | 3 | 100 |
| M321 | H₂SO₄ | HNO₃ | 3:1 | 3 | 6 | 60 |
| M322 | H₂SO₄ | HNO₃ | 3:1 | 3 | 6 | 100 |
| M323 | H₂SO₄ | HNO₃ | 3:1 | 3 | 24 | 60 |
| M324 | H₂SO₄ | HNO₃ | 3:1 | 3 | 24 | 100 |
| M325 | H₂SO₄ | HNO₃ | 3:1 | 8 | 3 | 60 |
| M326 | H₂SO₄ | HNO₃ | 3:1 | 8 | 3 | 100 |
| M327 | H₂SO₄ | HNO₃ | 3:1 | 8 | 6 | 60 |
| M328 | H₂SO₄ | HNO₃ | 3:1 | 8 | 6 | 100 |
| M329 | H₂SO₄ | HNO₃ | 3:1 | 8 | 24 | 60 |
| M330 | H₂SO₄ | HNO₃ | 3:1 | 8 | 24 | 100 |
| M331 | H₂SO₄ | HNO₃ | 3:1 | 16 | 3 | 60 |
| M332 | H₂SO₄ | HNO₃ | 3:1 | 16 | 3 | 100 |
| M333 | H₂SO₄ | HNO₃ | 3:1 | 16 | 6 | 60 |
| M334 | H₂SO₄ | HNO₃ | 3:1 | 16 | 6 | 100 |
| M335 | H₂SO₄ | HNO₃ | 3:1 | 16 | 24 | 60 |
| M336 | H₂SO₄ | HNO₃ | 3:1 | 16 | 24 | 100 |

Visual Dispersion Test.

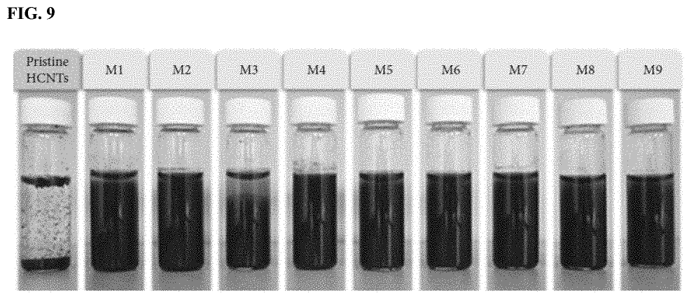

One objective of the chemical functionalization of nanomaterials is to improve their dispersion uniformity and suspension stability in different solutions and liquid resins. These are important requirements for successful incorporation of nanomaterials in polymeric composites, as reinforcements. The visual dispersion test is an easy and repeatable technique for assessment of the solubility and suspension stability of nanomaterials in solutions. Small amounts of chemically functionalized HCNTs were added to DI water inside closed-cap glass containers and then sonicated for certain periods of time. Later, these glass containers with FHCNTs solutions were placed on a stable platform and kept still to record their sedimentation rate after specific time intervals. FIG. 9 compares the dispersion uniformity and suspension stability of the functionalized HCNTs using different processes after one-week suspension in DI water. As it can be seen, the dispersion of functionalized HCNTs was fairly uniform for all functionalized HCNTs compared to the pristine HCNTs. In addition, the suspension of these FHCNTs did not change after one week. This confirms that our chemical functionalization processes (i.e., sonication with [3:1] mixture of sulfuric and nitric acids with different molarities) were successful for uniform dispersion and prolonged suspension of HCNTs in a liquid.

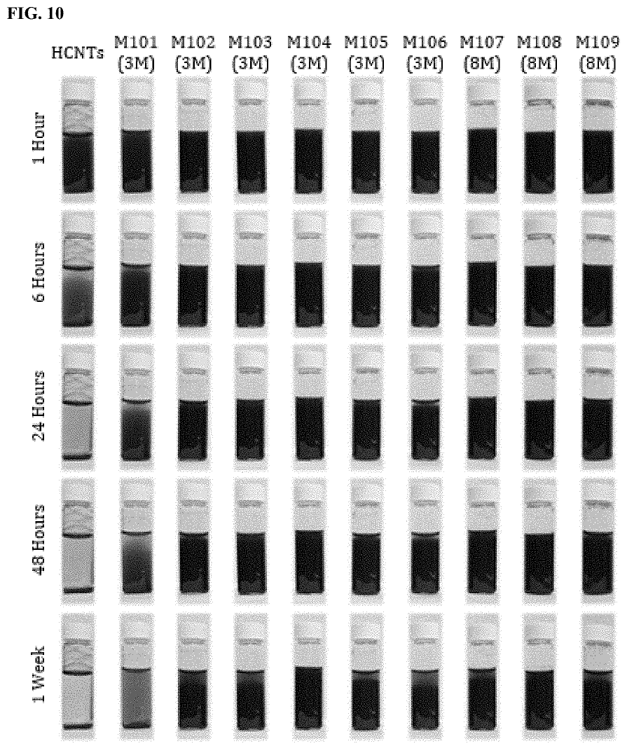

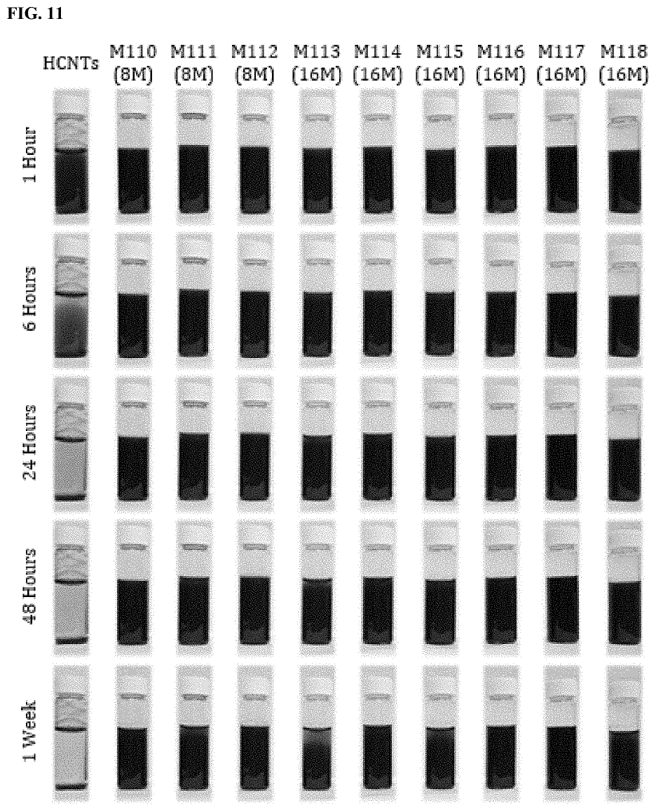

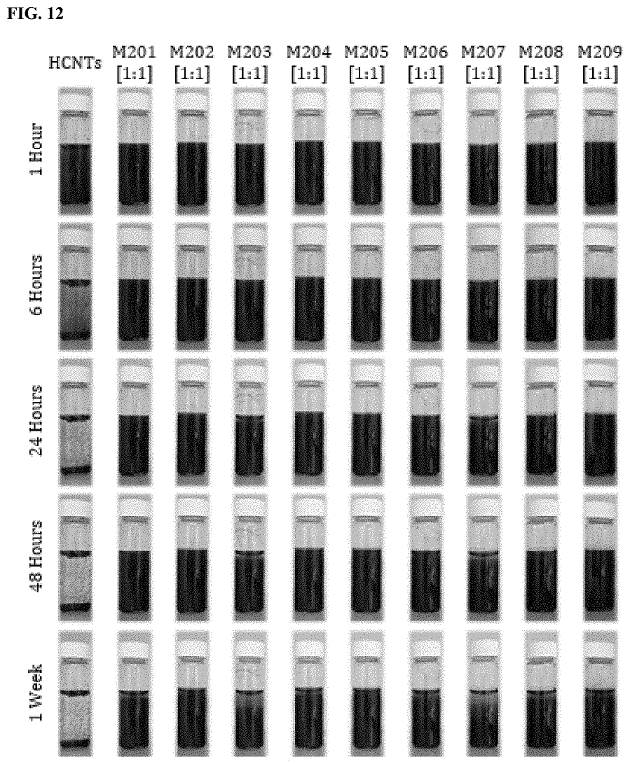

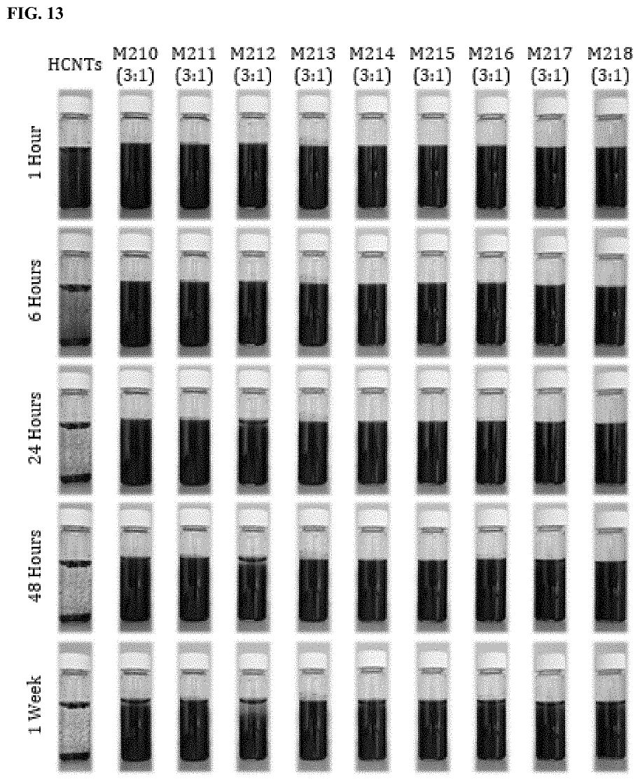

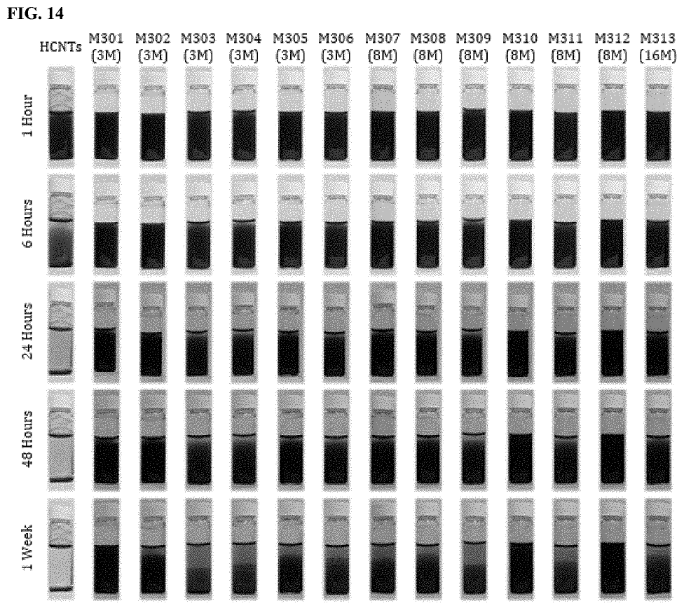

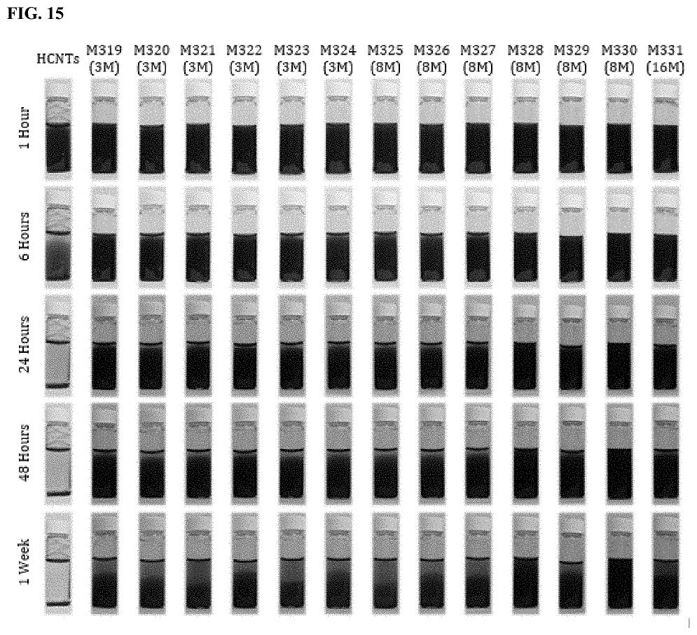

FIG. 9 presents images that show a comparison of the dispersion quality and stability of the HCNTs that were chemically functionalized using various processing parameters (i.e., sonication for 3, 6, and 9 hours with Sulfuric and Nitric acid mixture ratios of 1:1 and 3:1), after one-week seating time. The results confirmed that the functionalization processes were successful for uniform dispersion and stable suspension of the chemically functionalized HCNTs, even after one-week time pass. FIGS. 10-15 show the dispersion test results for all chemically functionalized HCNTs after 1 hour, 6 hours, 24 hours, 48 hours, and 1 week. As can be seen, most chemically functionalized HCNTs demonstrated a higher solubility compared to the untreated pristine HCNTs. However, a few of treated HCNTs had clear sedimentation after one week. Generally, results from the dispersion test showed that all processes increased the solubility of HCNTs drastically.

### Example 2: Characterization of Functionalized Helical CNTS

Raman Spectroscopy.

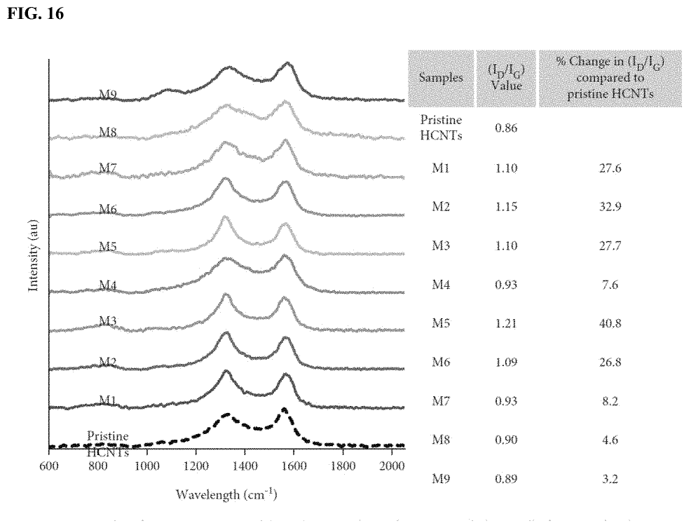

Raman spectroscopy is a technique used for identifying any disorder or change in the sp² carbon-carbon bonds [35]. Carbon nanotubes usually reveal two main peaks: D-band (1330 cm⁻¹) and G-band (1580 cm⁻¹), which are associated with the defect and graphitic structure, respectively, and the ratio of these two peaks can be used to evaluate the effectiveness of the employed chemical functionalization processes [36-39]. Here in this study, strong acids (i.e., sulfuric and nitric acids) were used to generate vacancy defects on perfect/inert crystalline structures of the HCNTs, which later can be used for attaching different functional groups. The existence of appropriate functional groups on the surface of functionalized HCNTs can lead to their improved solubility and dispersion uniformity in different resin systems. FIG. 16 presents and compares the two Raman spectral peaks of the functionalized HCNTs samples with respect to the pristine HCNTs and it illustrates the ratio of (I_{D}/I_{G}) bands. Based on these results, the ratio of (I_{D}/I_{G}) bands was increased for all functionalized HCNTs. This can be considered as an indication that the functionalization processes employed in this study were successful in generating more side-wall defects on the surface of HCNT structures.

In addition, it can be observed that for most of the FHCNTs samples the increase in molarity led to the reduction of I_{D}/I_{G} ratios. This can be seen for all samples which were sonicated for 9 hrs. The FHCNTs samples that were sonicated for 6 hours showed a higher I_{D}/I_{G} value when 8M acidic solution was used. In most cases, the ratio of I_{D}/I_{G} was reduced by increasing the sonication time. However, the FHCNTs samples that were sonicated with 3M and 8M acids showed lower I_{D}/I_{G} values than what was anticipated. The entanglement mechanisms of HCNTs can affect the I_{D}/I_{G} values obtained from Raman spectroscopy [23-27]. Due to their helical geometries with various coil diameters, some of the smaller HCNTs might get fully encapsulated inside larger diameter HCNTs and be protected. This can create some inconsistencies for the Raman spectroscopy results. However, all functionalized HCNTs showed an increase in their I_{D}/I_{G} values, which can be considered as a proof of their successful functionalization.

Fourier-Transform Infrared (FTIR) Spectroscopy.

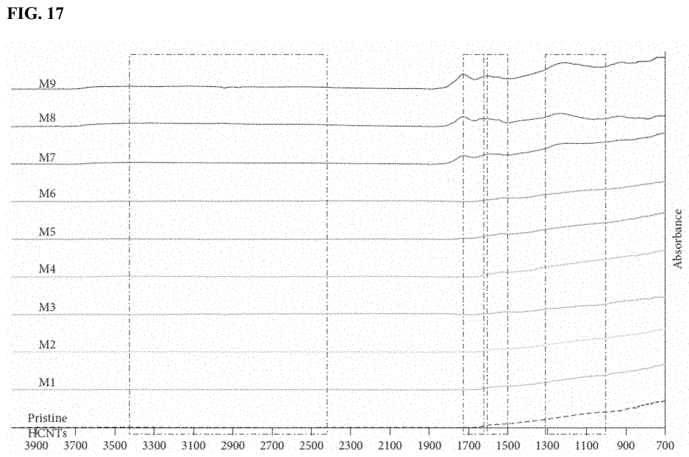

During the chemical functionalization process, the HCNTs go through surface modifications (i.e., the creation of atomic defect). Various functional groups can attach to the side-wall structures of the treated HCNTs, which can consequently lead to improved dispersion of these HCNTs in polymeric resins and give better/stronger interactions (i.e., interface properties/bonds) with polymer molecules. The FTIR is a qualitative technique that was used to distinguish attachments of various functional groups on the surface of HCNTs. In general, the functionalization process leads to changes in four regions of the FTIR spectra. These four regions are (—C—O) stretch between 1000 and 1300 cm⁻¹ [36, 40, 41], (—C═C) aromatic stretch between 1500 and 1600 cm⁻¹ [40-42], (—C═O) carboxylic acids between 1650 and 1730 cm⁻¹ [36, 40, 41, 43, 44], and (—O—H) carboxylic acids hydrogen stretch between 2400 and 3400 cm⁻¹ [37, 41, 42, 45]. FIG. 17 shows the FTIR spectra of the chemically functionalized HCNTs in comparison to the pristine HCNTs sample.

For the HCNTs that were functionalized using M7, M8, and M9 procedures (i.e., treated with a 16 M acidic solution), a clear change was observed in all regions of the FTIR spectra, except in the (—O—H) carboxylic acids hydrogen stretch between 2400 and 3400 cm⁻¹ spectrum. All other functionalization procedures (i.e., M1 through M6) showed small changes in their spectra compared to the pristine HCNTs sample. Overall, the presented results in this section confirmed that the employed functionalization processes used in this research (e.g., sonication with a [3:1] mixture of sulfuric and nitric acid solutions with 3, 8, and 16 molarities for 3, 6, and 9 hours processing times) were successful in surface modification of the HCNTs, where side-wall defects were generated and various functional groups were attached. This can lead to improved interaction of FHCNTs with polymeric resin molecules and enhance their dispersion uniformity for nanocomposites applications. However, using a stronger acidic solution with 16 molarity created a more substantial change in the FTIR spectra that could be an indication of severe side-wall defects on the surface of HCNTs structures.

X-Ray Diffraction (XRD).

The main objective for incorporation of chemically functionalized HCNTs into the resin systems is to enhance their mechanical properties and consequently, to improve the performance of polymeric nanocomposites for structural applications. The use of strong oxidants for chemical functionalization can lead to a reduction in crystallinity of the treated HCNTs (i.e., because of the generation of side-wall defects on the surfaces of CNTs) and hence, degradation of their mechanical properties and integrity. Therefore, it is essential to evaluate the structural crystallinity of functionalized HCNTs and make sure that they are not destroyed because of the exposure to strong acids. Here, XRD can provide valuable information about the purity of materials, dimensions of the unit cells, the structural crystallinity of materials, and physicochemical aspects of any configurations of CNTs [46-48]. In the case of CNTs, the data always demonstrates a big and sharp peak around 26°, which is related to the hexagonal graphitic structure [49, 50]. The intensity of these peaks and their comparison to pristine HCNTs can be used as a valuable indicator for crystallinity of the functionalized HCNTs samples. The presence of any amorphous carbon or defects can change the intensity of this peak.

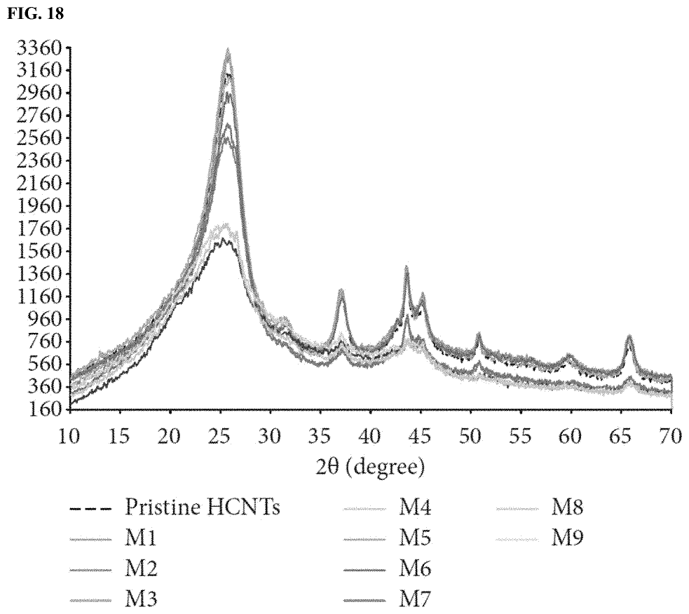

FIG. 18 shows the XRD data for the pristine and the chemically functionalized HCNTs. The results revealed that all the chemically treated HCNTs had a reduction in their structural crystallinity (i.e., reduction of spectral intensity of the peaks). However, the procedures that involved sonication with strong acidic solutions (i.e., procedures M7, M8, and M9 that uses acids with 16 M molarity) showed the largest reduction in crystallinity of the functionalized HCNTs. The value reduction in peak intensity for these procedures (i.e., M7 through M9) was nearly 38%; higher reductions are considered to be undesirable. It means that these chemically functionalized HCNTs cannot be as effective in providing considerable improvements in mechanical properties of polymeric nanocomposites. On the other hand, the chemical functionalization procedures M1 through M6 that demonstrated lower reductions in their peak intensities can be considered as more effective procedures for surface modification of HCNTs. These methods preserve the structural integrity of the HCNTs without generating severe damage to their structural crystallinity. As a result, procedures M1 through M6 can be considered more effective for chemical functionalization of HCNTs for structural nanocomposite applications. The resulting FHCNTs can be incorporated in polymeric resins and further investigated for their effectiveness as reinforcements in structural polymeric nanocomposites.

Scanning Electron Microscopy (SEM).

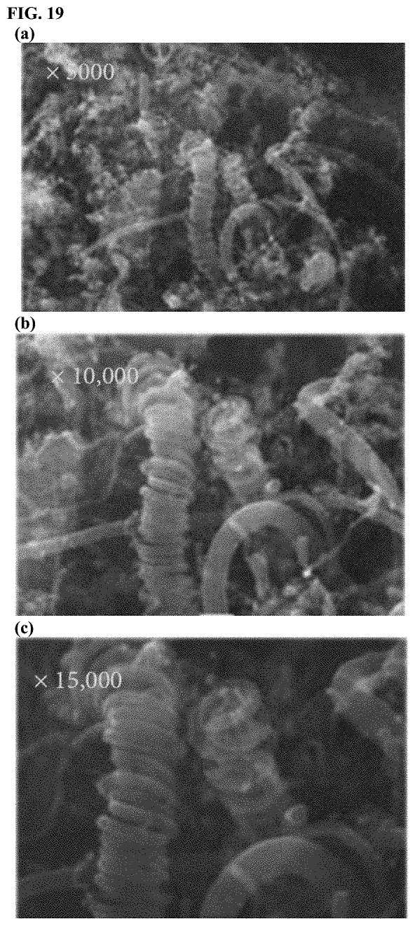

The SEM images were primarily used to observe and compare the structural integrity and configurations of the helical CNTs before and after functionalization process. In addition, SEM was used for imaging and understanding the structure, length, diameter, and morphology of the HCNTs [52-55], as a nondestructive characterization tool [56]. FIG. 19 shows the SEM images (i.e., invarious magnifications) of the pristine HCNTs that were used in this study for chemical functionalization. The pristine HCNTs were measured 1-10 μm in length and 100-200 nm in diameter.

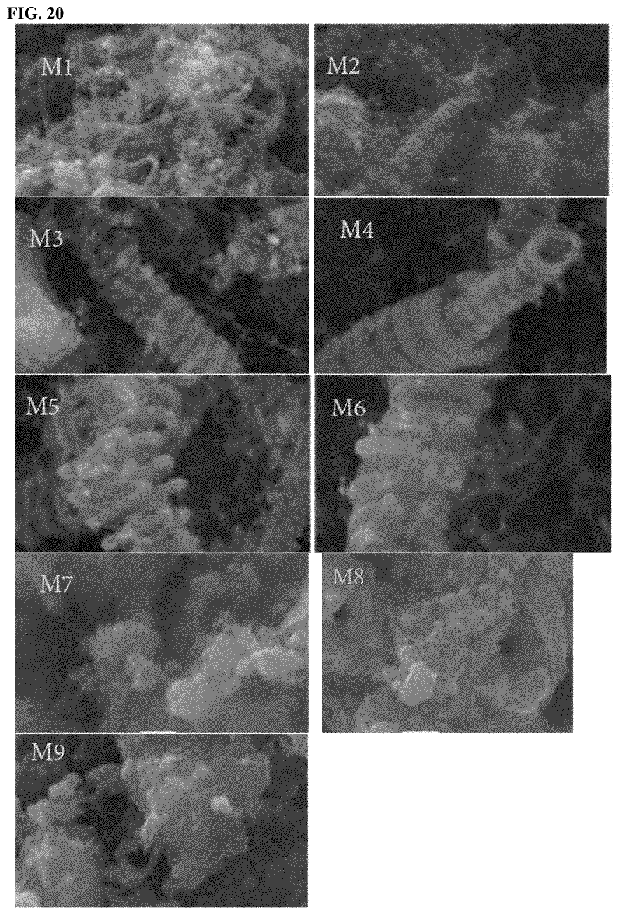

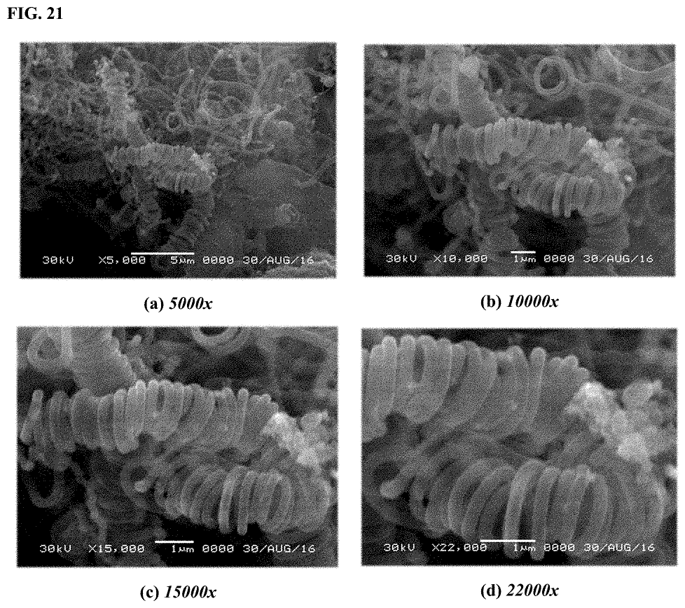

In this study, HCNTs were sonicated for different periods of time (i.e., 3, 6, and 9 hrs) in a mixture of sulfuric and nitric acid (i.e., with 3:1 mixing ratio) with different molarities (i.e., 3M, 8M, and 16M). FIG. 20 shows the SEM images (i.e., at ×15,000 magnification) of the HCNTs after they were chemically functionalized using 9 different procedures (i.e., M1 through M9). FIG. 21 presents SEM images for FHCNTs that were functionalized using sub-method 8 of the Method 3 (M308) with (a) 5000×, (b) 10000×, (c) 15000×, and (d) 22000× magnifications.

The comparison of the SEM images confirmed that the structure of HCNTs functionalized with M1 through M6 had gone through some minor alterations such as reduction in coil diameter, length, and shape. However, the HCNTs that were functionalized using stronger acids with 16 M molarity (i.e., procedures M7 through M9) were destroyed. This was consistent with the results that were obtained from both FTIR and XRD techniques.

These observations suggest that the use of harsher chemicals (i.e., high molarity acids) is not suitable for chemical functionalization of HCNTs that already include many periodic side-wall defects on their structures in forms of pentagonal and heptagonal rings. This explains that the use of strong acidic solutions can destroy the helical and graphitic structures of the HCNTs. The coil dimensions and configurations of these HCNTs may also influence the effectiveness of employed chemical functionalization methods [57]. An interesting observation was made in the SEM image of method M4 (shown in FIG. 20); here, a smaller-diameter HCNT was positioned inside a larger-diameter HCNT that could have been somewhat protected from the effects of acidic solutions. These concentric HCNTs can present very unique characteristics that could be utilized in nanoelectromechanical devices and sensors.

Effects of Acid Molarity.

To investigate the effects of acid molarity on the effectiveness of chemical functionalization of HCNTs, three different acid molarities (i.e., 3 M, 8 M, and 16 M) were used in this study. Considering the visual dispersion test results (shown in FIG. 9), no obvious differences were observed in dispersion uniformity and suspension stability of FHCNTs in DI water, except for the M3 samples that were sonicated with the lowest molarity acids (i.e., 3 M) for longest duration of time (i.e., 9 hours). The use of stronger acids with more than 3 M molarities can increase the solubility/dispersion of the HCNTs. However, the Raman spectroscopy results (shown in FIG. 16) demonstrated many discrepancies, and no clear correlation was observed to relate the changes in acid molarities to the variations of I_{D}/I_{G} values of the functionalized HCNTs. Regarding the XRD results (shown in FIG. 17), the use of stronger acids showed higher reduction in structural crystallinity of the chemically functionalized HCNTs, as expected. Furthermore, comparison of the FTIR spectra of the chemically functionalized HCNTs with the pristine HCNTs (shown in FIG. 18 showed changes in at least one of the four spectra regions. This could be an indication that the use of stronger acids can be more effective in surface modifications of HCNTs and attachments of functional groups on HCNTs surfaces

Effects of Sonication Time.

As mentioned before, in chemical functionalization methods M1, M2, and M3 the acid molarity was kept constant at 3 M while changing the sonication time from 3 to 9 hours in 3-hour increments (i.e., 3, 6, and 9 hours). Similarly, in methods M4, M5, and M6 the acid molarity was kept constant at 8 M, and in methods M7, M8, and M9 the acid molarity was highest and kept constant at 16 M while changing the sonication time in the same manner. Overall, for most FHCNTs samples the dispersion uniformity and suspension stability were improved and the extension of sonication time from 3 hours to 9 hours was not very influential. However, the HCNTs that were sonicated for 9 hours in a weak acidic solution with 3 M molarity (i.e., procedure M3) showed opposite results and the FHCNTs were partially precipitated and showed poor suspension stability. In regard to Raman spectroscopy I_{D}/I_{G} ratios, prolonging the sonication time from 3 hours to 6 hours increased the I_{D}/I_{G} ratio of HCNTs treated with 3 M and 8 M molarity acids. However, the I_{D}/I_{G} ratio for the FHCNTs sonicated for 9 hours showed a reduction compared to the FHCNTs that were treated for 6 hours. For the HCNTs that were functionalized using strong 16 M molarity acids, prolonging the functionalization process reduced the crystallinity of HCNTs; however, a consistent pattern was not observed for the HCNTs that were functionalized with 3 M and 8 M molarity acids. The FTIR spectra revealed that by prolonging the sonication process, most of the treated HCNTs had a change in their FTIR spectrum compared to the processes involving a shorter period of sonication time. Overall, a specific and consistent pattern in variations of the characterization results could not be observed because of the changes in sonication time. One possible reason could be the unique geometrical coil-shaped structures of HCNTs that increases their entanglements. Furthermore, the larger-diameter HCNTs that can potentially encapsulate the smaller-diameter HCNTs (see FIG. 20) may act as a shield, thus reducing the functionalization effects.

The as-purchased HCNTs batches contain impurities in forms of amorphous carbon, ash contents, and catalysis particles (i.e., nearly 10% by weight). During the sonication with strong acids, the side-wall defects start forming on the HCNTs, while acids attack and dissolve the impurities. After 3 hours of sonication, the combination of the generated side-wall defects and the remaining impurities results in lower crystallinity measurements compared to the original crystallinity of the as-purchased HCNTs. As the functionalization process proceeded beyond 3 hours and reached 6 hours, more side-wall defects were generated; however, most of the impurities can be dissolved and removed from the HCNTs. As a result, the overall crystallinity of the functionalized HCNTs can be higher than that of the as-purchased HCNTs in the absence of impurities. Once the process of functionalization continues and reaches the 9-hour timeline, more side-wall defects are generated on the structure of HCNTs reducing their crystallinity to less than that of the as-purchased pristine HCNTs. Therefore, considering the crystallinity of the HCNTs, 6-hour sonication time is the optimal processing time that can provide the highest crystallinity for HCNTs with minimal structural damage. In this study, small amounts of helical CNTs (e.g., nearly 1 gram for each method) were functionalized, using the presented methods (i.e., M1 through M9). Our goal was to incorporate these functionalized HCNTs (i.e., at very low weight percentages of less than 0.1%) into polymeric resins for nanocomposite applications [58]. However, one can scale-up these chemical processes to functionalize higher amounts of helical CNTs (e.g., tens to hundreds of grams), using larger size containers, bigger sonication bath, bigger filters, and an appropriately designed fume hood system that can accommodate the larger size experimental setups. However, in a lab setting the washing and drying of the functionalized helical CNTs might take longer time periods and considerable amounts of helical CNTs might be lost during this step. These processes can be designed more precisely and engineered professionally for high yields.

Having described the invention in detail, it will be apparent that modifications and variations are possible without departing from the scope of the invention defined in the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described herein. Publications, patent applications, patents, and other references mentioned herein are incorporated by reference in their entirety. In addition, the materials, methods, and examples are illustrative only and not intended to be limiting.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

### REFERENCES

[1] A. Bianco, K. Kostarelos, and M. Prato, “Applications of carbon nanotubes in drug delivery,” Current Opinion in Chemical Biology, vol. 9, no. 6, pp. 674-679, 2005.
[2] S. K. Vashist, D. Zheng, G. Pastorin, K. Al-Rubeaan, J. H. T. Luong, and F.-S. Sheu, “Delivery of drugs and biomolecules using carbon nanotubes,” Carbon, vol. 49, no. 13, pp. 4077-4097, 2011.
[3] D. Yu, K. Goh, H. Wang et al., “Scalable synthesis of hierarchically structured carbon nanotube-graphene fibres for capacitive energy storage,” Nature Nanotechnology, vol. 9, no. 7, pp. 555-562, 2014.
[4] Y. Qiu, G. Li, Y. Hou et al., “Vertically aligned carbon nanotubes on carbon nanofibers: a hierarchical three-dimensional carbon nanostructure for high-energy flexible supercapacitors,” Chemistry of Materials, vol. 27, no. 4, pp. 1194-1200, 2015.
[5] N. Islam and D. Askari, “Performance improvement of an AC electroosmotic micropump by hydrophobic surface modification,” Microfluidics and Nanofluidics, vol. 14, no. 3-4, pp. 627-635, 2013.
[6] S. Kumar, C. Lopez, O. Probst, G. Francisco, D. Askari, and Y. Yang, “Flow past a rotationally oscillating cylinder,” Journal of Fluid Mechanics, vol. 735, pp. 307-346, 2013.
[7] R. Jalilian, J. Rivera, D. Askari et al., “Toward wafer-scale patterning of freestanding intermetallic nanowires,” Nanotechnology, vol. 22, no. 29, p. 295601, 2011.
[8] D. Askari and G. Feng, “Finite element analysis of nanowire indentation on a flat substrate,” Journal of Materials Research, vol. 27, no. 3, pp. 586-591, 2012.
[9] X. Sun, H. Sun, H. Li, and H. Peng, “Developing polymer composite materials: carbon nanotubes or graphene?,” Advanced Materials, vol. 25, no. 37, pp. 5153-5176, 2013.
[10] M. N. Ghasemi-Nejhad, V. P. Veedu, A. Cao, P. Ajayan, and D. Askari, “Three-dimensionally reinforced multifunctional nanocomposites,” 2012, US-International Patent, 8148276.
[11] D. Askari and M. N. Ghasemi-Nejhad, “Effects of vertically aligned carbon nanotubes on shear performance of laminated nanocomposite bonded joints,” Science and Technology of Advanced Materials, vol. 13, no. 4, article 045002, 2012.
[12] M. N. Ghasemi-Nejhad and D. Askari, “Mechanical properties modeling of carbon single-walled nanotubes: a finite element method,” Journal of Computational and Theoretical Nanoscience, vol. 2, no. 2, pp. 298-318, 2005.
[13] V. P. Veedu, D. Askari, and M. N. Ghasemi-Nejhad, “Chirality dependence of carbon single-walled nanotube material properties: axial Young's modulus,” Journal of Nanoscience and Nanotechnology, vol. 6, no. 7, pp. 2159-2166, 2006.
[14] D. Askari and M. N. Ghasemi-Nejhad, “Effects of vacancy defects on mechanical properties of graphene/carbon nanotubes: a numerical modeling,” Journal of Computational and Theoretical Nanoscience, vol. 8, no. 4, pp. 783-794, 2011.
[15] D. Askari, V. P. Veedu, and M. N. Ghasemi-Nejhad, “Chirality dependence of carbon single-walled nanotube material properties: axial coefficient of thermal expansion,” Journal of Nanoscience and Nanotechnology, vol. 6, no. 7, pp. 2167-2174, 2006.
[16] D. Askari, V. P. Veedu, and M. N. Ghasemi-Nejhad, “A theoretical investigation on chirality dependence of single-walled carbon nanotubes thermal conductivity,” Nano Communications, vol. 1, no. 1, pp. 22-30, 2014.
[17] K. Chu, H. Guo, C. Jia et al., “Thermal properties of carbon nanotube-copper composites for thermal management applications,” Nanoscale Research Letters, vol. 5, no. 5, pp. 868-874, 2010.
[18] P. G. Collins and P. Avouris, “Nanotubes for electronics,” Scientific American, vol. 283, no. 6, pp. 62-69, 2000.
[19] J. Nilsson, A. H. C. Neto, F. Guinea, and N. M. R. Peres, “Electronic properties of graphene multilayers,” Physical Review Letters, vol. 97, no. 26, 2006.
[20] J. G. Park, J. Louis, Q. Cheng et al., “Electromagnetic interference shielding properties of carbon nanotube buckypaper composites,” Nanotechnology, vol. 20, no. 41, article 415702, 2009.
[21] J. N. Coleman, U. Khan, W. J. Blau, and Y. K. Gun′ko, “Small but strong: a review of the mechanical properties of carbon nanotube-polymer composites,” Carbon, vol. 44, no. 9, pp. 1624-1652, 2006.
[22] P. R. Unwin, A. G. Güell, and G. Zhang, “Nanoscale electrochemistry of sp2 carbon materials: from graphite and graphene to carbon nanotubes,” Accounts of Chemical Research, vol. 49, no. 9, pp. 2041-2048, 2016.
[23] S. Taklimi, A. Ghazinezami, K. Cluff PhD, K. Cluff PhD, and D. Askari, “Effects of reflux temperature and molarity of acidic solution on chemical functionalization of helical carbon nanotubes,” SAE International Journal of Materials and Manufacturing, vol. 11, no. 1, pp. 29-36, 2018.
[24] S. R. Taklimi, A. Ghazinezami, A. Heinrich, and D. Askari, Effects of Nitric-Sulfuric Acid Mixture Ratio and Sonication Time on Covalent Functionalization of Helical Carbon Nanotubes for Nanocomposite Applications Proceedings of the Society for the Advancement of Materials and Process Engineering (SAMPE), Long Beach, Calif., 2018.
[25] A. Ghazinezami, S. R. Taklimi, and D. Askari, Influence of Sonication Time and Molarities of Nitric and Sulfuric Acids on Effectiveness of Chemically Functionalized Helical Carbon Nanotubes for Nanocomposite Reinforcement Proceedings of the Society for the Advancement of Materials and Process Engineering (SAMPE), Long Beach, Calif., 2018.
[26] A. Ghazinezami, S. R. Hosseini-Taklimi, M. Khan, and
D. Askari, Effects of Functionalization Methods and Geometrical Configurations of Carbon Nanotubes on Properties of Polymeric Nanocomposites Proceedings of the Society for the Advancement of Materials and Process Engineering (SAMPE), Long Beach, Calif., 2016.
[27] S. R. Taklimi, “Effects of different processing parameters on covalent functionalization of straight and helical carbon nanotubes for nanocomposite applications PhD dissertation,” Wichita State University, Wichita, Kans., USA, 2017.
[28] P.-C. Ma, N. A. Siddiqui, G. Marom, and J. K. Kim, “Dispersion and functionalization of carbon nanotubes for polymer-based nanocomposites: a review,” Composites Part A: Applied Science and Manufacturing, vol. 41, no. 10, pp. 1345-1367, 2010.
[29] A. Shaikjee and N. J. Coville, “The synthesis, properties and uses of carbon materials with helical morphology,” Journal of Advanced Research, vol. 3, no. 3, pp. 195-223, 2012.
[30] J. A. Collins, H. R. Busby, and G. H. Staab, Mechanical Design of Machine Elements and Machines: A Failure Prevention Perspective, John Wiley & Sons, 2010.
[31] B. A. Korgel, “Nanosprings take shape,” Science, vol. 309, no. 5741, pp. 1683-1684, 2005.
[32] S. R. Hosseini-Taklimi, A. Ghazinezami, R. Vijayan, M. Ghazinejad, and D. Askari, Effects of CNTs Geometrical Configurations and Functionalization on Mechanical Properties of Polymeric Nanocomposites, American Composites Manufacturers Association (ACMA), Dallas, Tex., USA, 2015.
[33] K. T. Lau, M. Lu, and D. Hui, “Coiled carbon nanotubes: synthesis and their potential applications in advanced composite structures,” Composites. Part B, Engineering, vol. 37, no. 6, pp. 437-448, 2006.
[34] W. Pan, M. He, X. Bu et al., “Microwave absorption and infrared emissivity of helical polyacetylene@multiwalled carbon nanotubes composites,” Journal of Materials Science: Materials in Electronics, vol. 28, no. 12, pp. 8601-8610, 2017.
[35] A. G. Osorio, I. C. L. Silveira, V. L. Bueno, and C. P. Bergmann, “H₂SO₄/HNO₃/HCl—functionalization and its effect on dispersion of carbon nanotubes in aqueous media,” Applied Surface Science, vol. 255, no. 5, Part 1, pp. 2485-2489, 2008.
[36] R. Arrigo, N. T. Dintcheva, M. Guenzi et al., “Thermo-oxidative resistant nanocomposites containing novel hybrid-nanoparticles based on natural polyphenol and carbon nanotubes,” Polymer Degradation and Stability, vol. 115, pp. 129-137, 2015.
[37] R. E. C. Torrejos, G. M. Nisola, M. J. Park et al., “Synthesis and characterization of multi-walled carbon nanotubes-supported dibenzo-14-crown-4 ether with proton ionizable carboxyl sidearm as Li+ adsorbents,” Chemical Engineering Journal, vol. 264, pp. 89-98, 2015.
[38] N. M. Mubarak, J. N. Sahu, E. C. Abdullah, N. S. Jayakumar, and P. Ganesan, “Single stage production of carbon nanotubes using microwave technology,” Diamond and Related Materials, vol. 48, pp. 52-59, 2014.
[39] S. L. H. Rebelo, A. Guedes, M. E. Szefczyk, A. M. Pereira, J. P. Araujo, and C. Freire, “Progress in the Raman spectra analysis of covalently functionalized multiwalled carbon nanotubes: unraveling disorder in graphitic materials,” Physical Chemistry Chemical Physics, vol. 18, no. 18, pp. 12784-12796, 2016.
[40] J. Gao, S. Zhang, M. Liu et al., “Synergistic combination of cyclodextrin edge-functionalized graphene and multiwall carbon nanotubes as conductive bridges toward enhanced sensing response of supramolecular recognition,” Electrochimica Acta, vol. 187, pp. 364-374, 2016.
[41] N. M. Yatim, A. Shaaban, M. F. Dimin, and F. Yusof, “Statistical evaluation of the production of urea fertilizer-multiwalled carbon nanotubes using Plackett Burman experimental design,” Procedia Social and Behavioral Sciences, vol. 195, pp. 315-323, 2015.
[42] V. Vinoth, J. J. Wu, A. M. Asiri, and S. Anandan, “Simultaneous detection of dopamine and ascorbic acid using silicate network interlinked gold nanoparticles and multi-walled carbon nanotubes,” Sensors and Actuators B: Chemical, vol. 210, pp. 731-741, 2015.
[43] M. Jahangiri, F. Kiani, H. Tahermansouri, and A. Rajabalinezhad, “The removal of lead ions from aqueous solutions by modified multi-walled carbon nanotubes with 1-isatin-3-thiosemicarbazone,” Journal of Molecular Liquids, vol. 212, pp. 219-226, 2015.
[44] M. Shanbedi, S. Z. Heris, A. Amiri, and H. Eshghi, “Synthesis of water-soluble Fe-decorated multi-walled carbon nanotubes: a study on thermo-physical properties of ferromagnetic nanofluid,” Journal of the Taiwan Institute of Chemical Engineers, vol. 60, pp. 547-554, 2016.
[45] R. Escudero-Cid, A. S. Varela, P. Hernández-Fernández, E. Fatás, and P. Ocón, “The effect of functionalised multi-walled carbon nanotubes in the hydrogen electrooxidation reaction in reactive currents impurified with CO,” International Journal of Hydrogen Energy, vol. 39, no. 10, pp. 5063-5073, 2014.
[46] T. Altalhi, M. Ginic-Markovic, N. Han, S. Clarke, and D. Losic, “Synthesis of carbon nanotube (CNT) composite membranes,” Membranes, vol. 1, no. 1, pp. 37-47, 2011.
[47] J. Cambedouzou, M. Chorro, R. Almairac et al., “X-ray diffraction as a tool for the determination of the structure of double-walled carbon nanotube batches,” Physical Review B, vol. 79, no. 19, 2009.
[48] L. A. Dobrzanski, M. Pawlyta, A. Krzton, B. Liszka, C. W. Tai, and W. Kwasny, “Synthesis and characterization of carbon nanotubes decorated with gold nanoparticles,” Acta Physica Polonica A, vol. 118, no. 3, pp. 483-486, 2010.
[49] Q. Kong and J. Zhang, “Synthesis of straight and helical carbon nanotubes from catalytic pyrolysis of polyethylene,” Polymer Degradation and Stability, vol. 92, no. 11, pp. 2005-2010, 2007.
[50] Y. Chen, H. Jiang, D. Li et al., “Improved field emission performance of carbon nanotube by introducing copper metallic particles,” Nanoscale Research Letters, vol. 6, no. 1, p. 537, 2011.
[51] D. Berhanu, A. Dybowska, S. K. Misra et al., “Characterisation of carbon nanotubes in the context of toxicity studies,” Environmental Health, vol. 8, Supplement 1, p. S3, 2009.
[52] R. Herrera-Basurto, Á. I. López-Lorente, and M. Valcárcel, “Scanning electron microscopy of carbon nanotubes dispersed in ionic liquid: solvent influence study,” Microchemical Journal, vol. 122, pp. 137-143, 2015.
[53] S. Bibi, R. Kaur, M. Henriksen-Lacey et al., “Microscopy imaging of liposomes: from coverslips to environmental SEM,” International Journal of Pharmaceutics, vol. 417, no. 1-2, pp. 138-150, 2011.
[54] K. H. Guenther, “Nonoptical characterization of optical coatings,” Applied Optics, vol. 20, no. 20, pp. 3487-3502, 1981.
[55] K. Safarova, A. Dvorak, R. Kubinek, M. Vujtek, and A. Rek, “Usage of AFM, SEM and TEM for the research of carbon nanotubes,” Modern Research and Educational Topics in Microscopy, vol. 2, pp. 513-519, 2007.
[56] J. H. Lehman, M. Terrones, E. Mansfield, K. E. Hurst, and V. Meunier, “Evaluating the characteristics of multiwall carbon nanotubes,” Carbon, vol. 49, no. 8, pp. 2581-2602, 2011.
[57] S. R. Taklimi, A. Ghazinezami, and D. Askari, “The geometrical advantages of helical carbon nanotubes for high-performance multifunctional polymeric nanocomposites,” Journal of Nanomaterials, vol. 2019, Article ID 2836372, 10 pages, 2019.
[58] R. Vijayan, A. Ghazinezami, S. R. Taklimi, M. Y. Khan, and D. Askari, “The geometrical advantages of helical carbon nanotubes for high-performance multifunctional polymeric nanocomposites,” Composites Part B: Engineering, vol. 156, pp. 28-42, 2019.

1. A nanocomposite material comprising:
a first microfiber;
a second microfiber; and
a plurality of chemically functionalized helical nanostructures coupling the first and second microfibers, and the plurality of chemically functionalized helical nanostructures comprise functionalized helical carbon nanotubes.

2-16. (canceled)

17. A process for preparing a functionalized helical carbon nanotube, the process comprising:
mixing a helical carbon nanotube with an acid in a reaction mixture to form the functionalized helical carbon nanotube.

18. The process of claim 17, wherein the process further comprises separating the functionalized helical carbon nanotube from the reaction mixture.

19. (canceled)

20. The process of claim 17, wherein the process further comprises drying the functionalized helical carbon nanotube.

21. The process of claim 17, wherein the process further comprises sonicating the reaction mixture.

22. The process of claim 17, wherein the acid comprises a strong acid.

23. (canceled)

24. The process of claim 17, wherein the acid comprises sulfuric acid and/or nitric acid.

25. (canceled)

26. The process of claim 17, wherein the reaction mixture has a concentration of acid that is from about 1 M to about 20 M, from about 1 M to about 16 M, from about 1 M to about 12 M, from about 1 M to about 8 M, from about 1 M to about 4 M, from about 2 M to about 20 M, from about 2 M to about 16 M, from about 2 M to about 12 M, from about 2 M to about 8 M, from about 2 M to about 4 M, from about 3 M to about 20 M, from about 3 M to about 16 M, from about 3 M to about 12 M, from about 3 M to about 8 M, or from about 3 M to about 4 M.

27. The process of claim 17, wherein the acid comprises a combination of sulfuric acid and nitric acid at a molar ratio from about 1:1 to about 10:1, from about 1:1 to about 5:1, from about 1:1 to about 3:1, from about 2:1 to about 10:1, from about 2:1 to about 5:1, from about 2:1 to about 3:1.

28. (canceled)

29. The process of claim 17, wherein the reaction mixture is maintained at a temperature of from about 50° C. to about 120° C., from about 60° C. to about 120° C., from about 80° C. to about 120° C., from about 50° C. to about 100° C., from about 60° C. to about 100° C., or from about 80° C. to about 100° C.

30. The process of claim 17, wherein the process further comprises refluxing a solution comprising acid with the reaction mixture.

31. (canceled)

32. The process of claim 30, wherein the solution comprising acid is at a temperature of from about 50° C. to about 120° C., from about 60° C. to about 120° C., from about 80° C. to about 120° C., from about 50° C. to about 100° C., from about 60° C. to about 100° C., or from about 80° C. to about 100° C.

33. The process of claim 30, wherein the solution comprising acid comprises the acid(s) contained in the reaction mixture.

34. The process of claim 17, wherein the helical carbon nanotube has:
an outside diameter ranging from about 100 nm to about 200 nm;
a helical coil pitch ranging from about 100 nm to about 1000 nm; and/or
a length ranging from about 1 micron to about 10 microns.

35. (canceled)

36. (canceled)

37. A functionalized helical carbon nanotube prepared according to the process of claim 17.

38. A process for preparing a nanocomposite material, the process comprising:
mixing a microfiber with a functionalized helical carbon nanotube prepared according to the process of claim 17.

39. The process of claim 38, wherein the microfiber is selected from the group consisting of glass, a para-aramid synthetic fiber, carbon, silicon carbide, boron, aluminum oxide, or combinations thereof.

40. A composition comprising a functionalized helical carbon nanotube (FHCNT), wherein the FHCNT is characterized by one or more of the following:
(a) a plurality of the FHCNTs forms a stable suspension with water at room temperature, wherein at least about 75 wt. %, at least about 90 wt. %, at least about 95 wt. %, or at least about 99 wt. % of the FHCNT remains suspended in the water after one week of storage at room temperature;
(b) an amount of the FHCNTs forms a suspension in water at room temperature having a greater optical opacity as compared to a suspension having approximately the same amount of an otherwise similar helical carbon nanotubes, but which are pristine/non-functionalized;
(c) the FHCNT has an increased I_{D}/I_{G} value as determined by Raman spectroscopy as compared to an otherwise similar helical carbon nanotube, but which is pristine/non-functionalized;
(d) the FHCNT exhibits a decrease crystallinity as determined by X-Ray diffraction as compared to an otherwise similar helical carbon nanotube; and/or
(e) the FHCNT has a peak at 26° as determined by X-Ray diffraction that is less than the peak 26° for an otherwise similar helical carbon nanotube.

41. A liquid composition comprising a plurality of FHCNTs of claim 40 dispersed in a liquid medium.

42. (canceled)

43. A composite material comprising a plurality of FHCNTs of claim 40 and at least one additional component comprising at least one material selected from the group consisting of glass, polymer, ceramic, metal, carbon, silicon carbide, boron, aluminum oxide, and combinations thereof.

44-47. (canceled)
